(19) United States
(12) Patent Application Publication
(10) Pub. No.: US 2004/0262525 A1
(43) Pub. Date: Dec. 30, 2004

(54) Nuclear medicine gantry and method

(76) Inventors: David A. Yunker, Cicero, IL (US); John Thomas Pawlak, Villa Park, IL (US)

Correspondence Address: Siemens Corporation, Intellectual Property Department, 170 Wood Avenue South, Iselin, NJ, 08830, US

(21) Appl. No.: 10/609,738

(22) Filed: Jun. 30, 2003

(51) Int. Cl. G01T 1/164

(52) U.S. Cl. 250/363.08

(57) ABSTRACT

A nuclear medicine gantry is provided and includes a ring defining a central longitudinal axis. The nuclear medicine gantry further includes at least one detector head mounted to the ring. The at least one detector head is rotatable about the longitudinal axis, movable in radial directions relative to the longitudinal axis, movable in tangential directions relative to a circle whose center is coincident with the longitudinal axis, and pivotable about a first pivot axis which is parallel to the longitudinal axis.

### BACKGROUND OF THE INVENTION

1. Field of the Invention

The present invention generally relates to nuclear medicine and, more particularly, to systems and methods for obtaining nuclear medicine images of a patient's body and/or organs of interest.

2. Description of the Background Art

Nuclear medicine is a unique medical specialty wherein radiation is used to acquire images which show the function and anatomy of organs, bones or tissues of the body. Radiopharmaceuticals are introduced into the body, either by injection or ingestion, and are attracted to specific organs, bones or tissues of interest. Such radiopharmaceuticals produce gamma photon emissions which emanate from the body. One or more detector heads are used to detect the emitted gamma photons, and the information collected from the detector head(s) is processed to calculate the position of origin of the emitted photon from the source (i.e., the body organ or tissue under study). The accumulation of a large number of emitted gamma positions allows an image of the organ or tissue under study to be displayed.

There are basically two types of imaging techniques, namely, positron emission tomography (PET) and single photon emission computed tomography (SPECT). Both PET and SPECT require gamma ray detector head(s) that calculate and store both the position of the detected gamma ray and its energy. Typically, detector head(s) include a scintillation plate which converts each received radiation event (e.g., the emitted gamma photons) into a scintillation or flash of light. An array of photomultiplier tubes positioned behind the scintillation plate and associated circuitry determine a coordinate location and a value of energy for each scintillation event.

Until recently, SPECT imaging, used a single detector head which is rotated about the subject or indexed to a multiplicity of angularly offset positions around the subject to collect a series of data sets. More recently, instead of using a single detector head, two detector heads are positioned on opposite sides of the subject. Use of two detector heads typically improves the data collection efficiency.

In addition, some systems use three detector heads placed at 120° intervals around the subject. In these systems, the detector heads are typically movable in directions radially toward and away from the patient and the three detector heads are rotatable, as a unit, around the patient.

Each of the foregoing systems has various advantages and disadvantages. In particular, while the foregoing systems provide a certain degree of increased range of motion and field of coverage, there remains a need in the art for systems and methods of performing imaging having increased flexibility and an improved field of coverage as compared to the prior art systems.

### SUMMARY OF THE INVENTION

Systems and methods for obtaining nuclear medicine images of a patient's body and/or organs of interest are disclosed.

According to one system, a nuclear medicine gantry is provided and includes a ring defining a central longitudinal axis. The nuclear medicine gantry further includes at least one detector head mounted to the ring. The at least one detector head is rotatable about the longitudinal axis, movable in radial directions relative to the longitudinal axis, movable in tangential directions relative to a circle, the center of which lies on the longitudinal axis, and pivotable about a first pivot axis which is parallel to the longitudinal axis.

A method of performing an image scan is provided. The method includes the step of providing a nuclear medicine gantry as described above. The method further includes the steps of performing at least one of a 180° tomography, a 90° Cardiac tomography, a circular scan acquisition, a non-circular orbit scan acquisition, a non-circular pre-scan acquisition, a CT cardiac attenuation correction, an extra wide whole-body planar acquisition, extra-wide SPECT imaging, and an MUGA.

It is further contemplated that the method can further include the step of configuring the nuclear medicine gantry to perform at least one of an image acquisition over a gurney, of an image acquisition of an individual standing between the first and second detector heads, and of an image acquisition of an individual positioned radially outward of the first and second detector heads.

The above is a brief description of some deficiencies in the prior art and advantages of the present invention. Other features, advantages and embodiments of the invention will be apparent to those skilled in the art from the following description, drawings and claims.

### BRIEF DESCRIPTION OF THE DRAWINGS

The invention will become more clearly understood from the following detailed description in connection with the accompanying drawings, in which:

FIG. 1 is a front perspective view of a nuclear medicine gantry in accordance with an embodiment of the present disclosure, illustrating detector heads in a 180° orientation relative to one another;

FIG. 2 is a front elevational view of the nuclear medicine gantry of FIG. 1 illustrating the degrees of motion thereof;

FIG. 3 is a front elevational view of the nuclear medicine gantry of FIGS. 1-2 illustrating the ability to perform extra-wide whole body images;

FIG. 4 is a front elevational view of the nuclear medicine gantry of FIGS. 1-3 illustrating the ability to do extra-large SPECT images;

FIG. 5 is a front perspective view of the nuclear medicine gantry of FIGS. 1-4 in combination with a linear telescoping bed;

FIG. 6 is a rear perspective view of the nuclear medicine gantry and the linear telescoping bed of FIG. 5, illustrating the positioning of a patient through the ring of the nuclear medicine gantry;

FIG. 7 is a top plan view of the nuclear medicine gantry and the linear telescoping bed of FIGS. 5-6, illustrating the positioning of the patient through the ring of the nuclear medicine gantry;

FIG. 8 is a rear perspective view of the nuclear medicine gantry and the linear telescoping bed of FIGS. 5-7, including a CT scanner and illustrating the positioning of the patient through the ring of the nuclear medicine gantry and the CT scanner;

FIG. 9 is a top plan view of the nuclear medicine gantry and the linear telescoping bed of FIG. 8, illustrating the positioning of the patient through the ring of the nuclear medicine gantry and the CT scanner;

FIG. 10 is a front perspective view of the nuclear medicine gantry and the linear telescoping bed of FIGS. 5-7 further illustrating the use of a cart carrying a plurality of collimators for use in connection with at least one of the detector heads;

FIG. 11 is a front perspective view of the nuclear medicine gantry of FIGS. 1-4 for use with a gurney, illustrating the detector heads in a 0° orientation relative to one another;

FIG. 12 is a front plan view of the nuclear medicine gantry of FIG. 11;

FIG. 13 is a front plan view of the nuclear medicine gantry of FIGS. 11-12 illustrating the ability of the nuclear medicine gantry to do whole body images of patients while on the gurney;

FIG. 14 is a front perspective view of the nuclear medicine gantry of FIGS. 1-4 illustrating the detector heads in a 90° orientation to one another;

FIG. 15 is a front elevational view of the nuclear medicine gantry of FIG. 14;

FIG. 16 is a front perspective view of the nuclear medicine gantry of FIGS. 14-15 illustrating the positioning of a patient on a linear telescoping bed and through the ring thereof;

FIG. 17 is a front perspective view of the nuclear medicine gantry of FIGS. 1-4 illustrating the use of a yoke for orientation of a detector head for preparation of MUGA studies;

FIG. 18 is a front perspective view of the nuclear medicine gantry of FIGS. 1-4 illustrating use of the yoke for orientation of the detector head for imaging of a patient seated in a chair;

FIG. 19A is a front perspective view of a nuclear medicine gantry including a single detector head;

FIG. 19B is a front perspective view of a nuclear medicine gantry including a pair of detector heads in fixed juxtaposed position; and

FIG. 19C is a front perspective view of a nuclear medicine gantry including five detector heads is fixed angled position relative to one another and further including a CT scanner.

### DETAILED DESCRIPTION OF THE PREFERRED EMBODIMENTS

The following description is presented to enable one of ordinary skill in the art to make and use the invention and is provided in the context of a patent application and its requirements. Various modifications to the preferred embodiments will be readily apparent to those skilled in the art and the generic principles herein may be applied to other embodiments. Thus, the present invention is not intended to be limited to the embodiment shown but is to be accorded the widest scope consistent with the principles and features described herein.

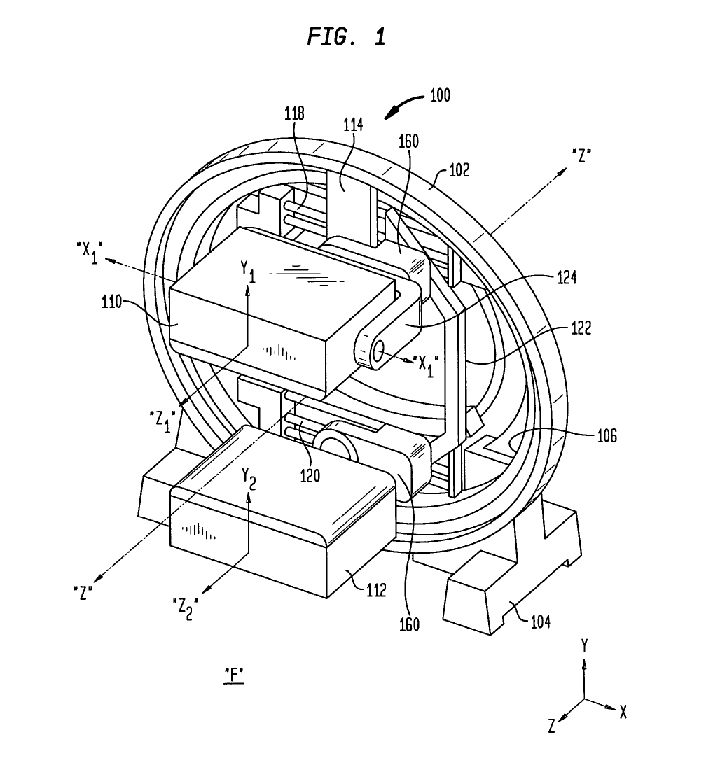

Referring now to the drawings, and first to FIGS. 1-4, a nuclear medicine gantry in accordance with the present invention is shown and generally indicated at 100. Nuclear medicine gantry 100 includes a ring 102 operatively connected to and supported on a stand 104. Ring 102 is supported on stand 104 in such a manner that a central longitudinal Z axis of ring 102 is oriented in a plane substantially parallel to floor “F”. Ring 102 defines an X-Y plane.

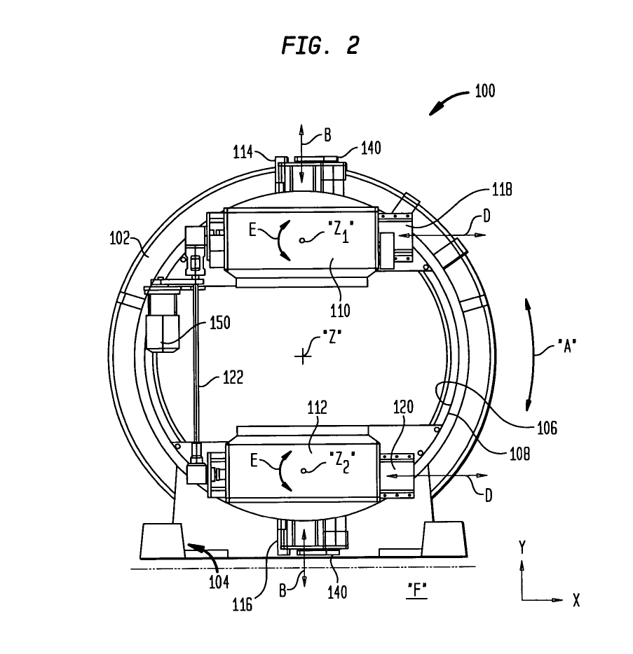

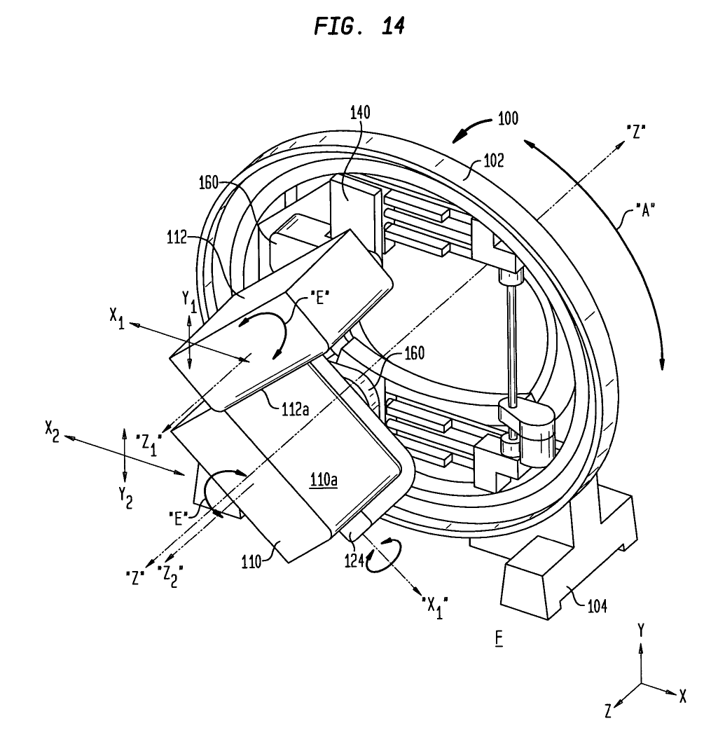

Ring 102 defines a inner annular race 106, rotatable about the longitudinal Z axis, including a series of teeth 108, in the form of a gear, along substantially the entire circumference of inner annular race 106. In addition, stand 104 can be provided with a drive mechanism (not shown) including a gear, in the form of a pinion, which is configured and dimensioned to engage and cooperate with teeth 108 of race 106 (see FIG. 2). In this manner, rotation of the gear of the drive mechanism results in rotation of race 106 about the longitudinal Z axis as indicated by double-headed arrow “A” in FIGS. 2 and 14. While one method of rotating race 106 about the longitudinal Z axis has been described, it will be readily apparent to those skilled in the art that other methods of rotating race 106 about the longitudinal Z axis can be provided and are intended to be included in the present invention.

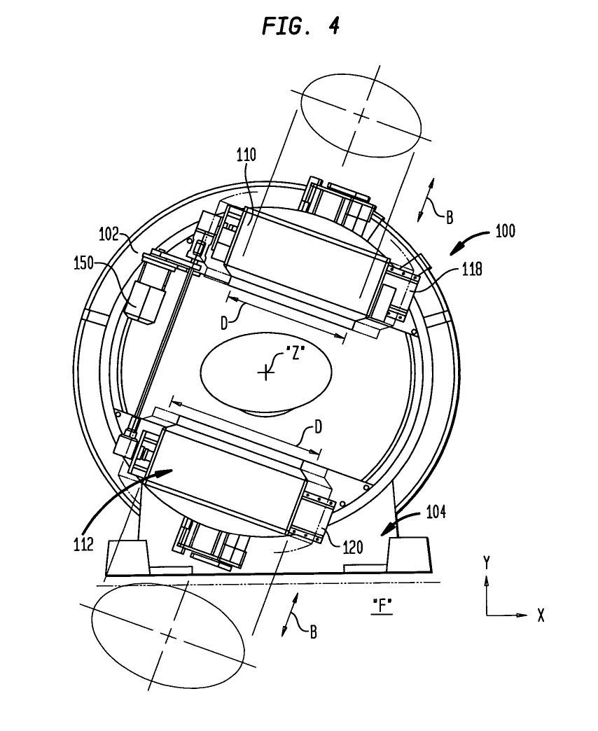

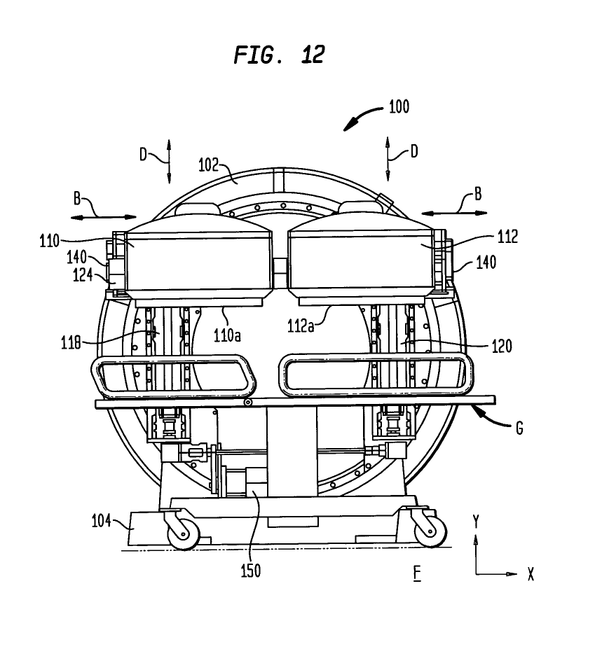

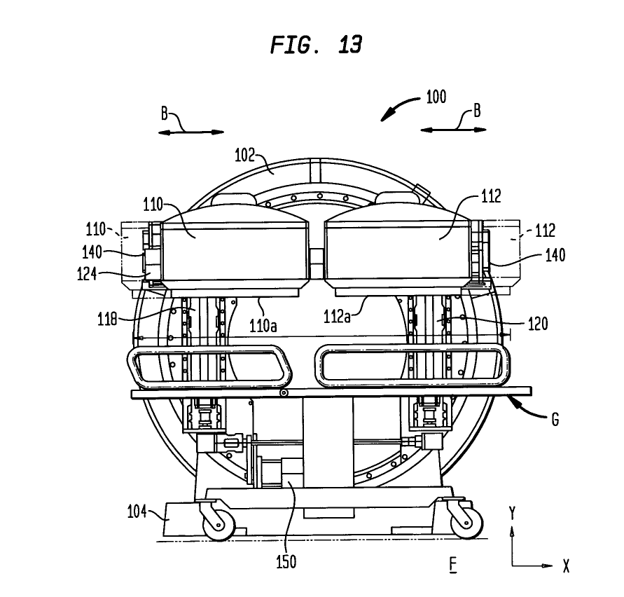

Nuclear medicine gantry 100 further includes a first detector head 110 and a second detector head 112, each detector head 110, 112 being operatively associated with and/or mounted to race 106. As seen in FIGS. 1-4, each detector head 110, 112 is operatively mounted to a respective first rail 114, 116. Each first rail 114 and 116 is oriented in a direction radial to the longitudinal axis Z of ring 102. In this manner, each detector head 110, 112 is independently translatable, along a respective first rail 114, 116, in directions radial to the longitudinal Z axis (e.g., radially inward toward the longitudinal Z axis and/or radially outward away from the longitudinal Z axis). For example, depending on the radial orientation of race 106 about the longitudinal Z axis, each detector head 110, 112 can be translated, in a radial direction, along at least one of an X axis (as indicated by double-headed arrows “B” in FIG. 13), a Y axis (see FIGS. 2 and 12) or an axis oriented at an angle between the X and Y axes (see FIG. 4).

Nuclear medicine gantry 100 further includes a radial drive mechanism 140 operatively associated with each detector head 110, 112. In this manner, radial drive mechanisms 140 can translate each detector head 110, 112 along radially oriented first rails 114, 116. Radial drive mechanisms 140 can include, and are not limited to, mechanical drive mechanisms and/or pneumatic drive mechanisms.

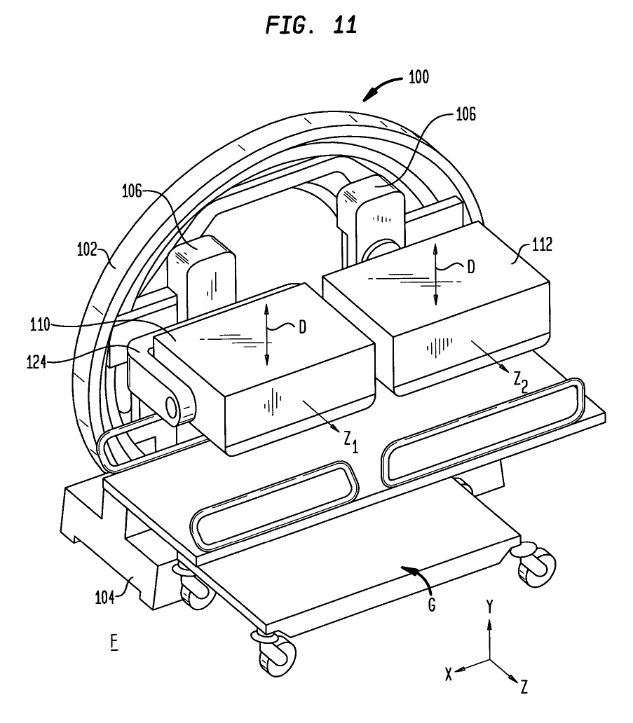

As seen in FIGS. 1-4, each detector head 110, 112 is operatively mounted to a respective second rail 118, 120. Each second rail 118, 120 is oriented in a direction normal to first rails 114, 116 (or alternatively, tangential to the longitudinal Z axis of ring 102). In this manner, detector heads 110, 112 are translatable, along respective second rails 118, 120, in directions tangential a circle whose center is coincident with the to the longitudinal Z axis. For example, depending on the radial orientation of race 106 about the longitudinal Z axis, each detector head 110, 112 can be translated, in a tangential direction, along at least one of an X axis (as indicated by double-headed arrow “D” in FIG. 2), a Y axis (as indicated by double-headed arrow “D” in FIGS. 11-12) or an axis oriented at an angle between the X and Y axes (as indicated by double-headed arrow “D” in FIG. 4).

Nuclear medicine gantry 100 further includes a tangential drive mechanism 150 operatively associated with detector heads 110, 112. In this manner, tangential drive mechanism 150 can translate each detector head 110, 112 along tangentially oriented second rails 118, 120. Tangential drive mechanism 150 can include, and is not limited to, a mechanical drive mechanism and/or a pneumatic drive mechanism.

Detector heads 110, 112 are operatively linked to one another via a frame member 122 in such a manner that tangential drive mechanism 150 simultaneously translates both detector heads 110 and 112, in a selected tangential direction along its respective second rail 118, 120. In this manner, a single tangential drive mechanism is needed to effectuate tangential movement of detector heads 110, 112. Alternatively, it is envisioned that each detector head 110, 112 can be operatively associated with its own respective drive mechanism (not shown) for imparting independent tangential movement of detector heads 110, 112.

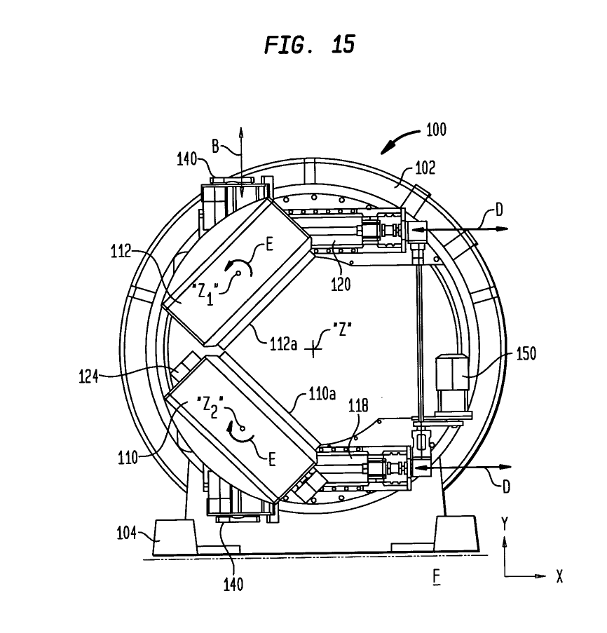

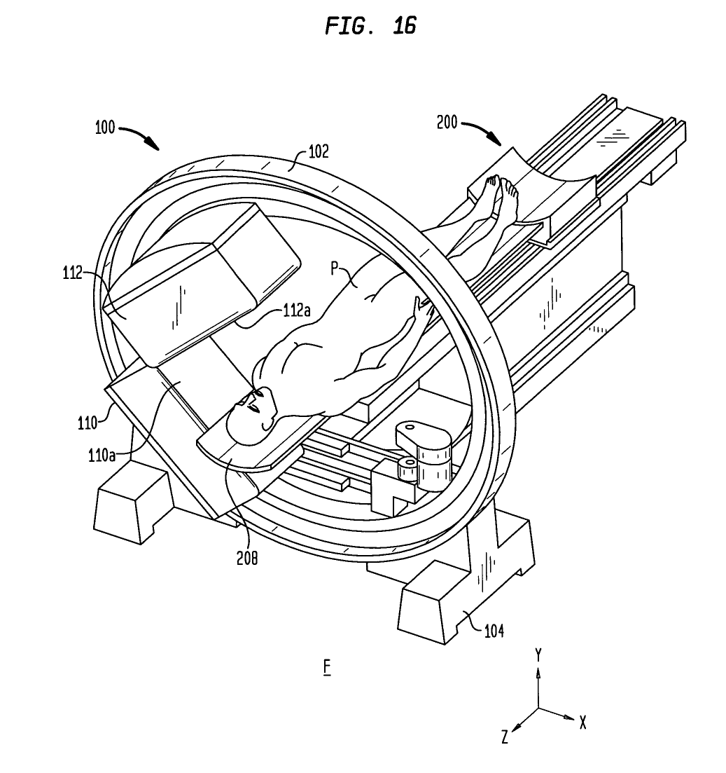

Each detector head 110, 112 is operatively mounted to ring 102 such that each detector head 110, 112 is independently pivotable about a respective longitudinal axis Z₁, Z₂. Preferably, longitudinal axes Z₁, Z₂ are each oriented to be substantially parallel with longitudinal axis Z of ring 102. In this manner, each detector head 110, 112 is pivotable independently pivotable such that detector heads 110, 112 can be oriented in juxtaposed relation to one another, i.e., 180°, (see FIGS. 1-10), orthogonal relation to one another, i.e., 90°, (see FIGS. 14-16), in co-planar relation to one another, i.e., 0°, (see FIGS. 11-13), and any other angle relative to one another.

Nuclear medicine gantry 100 further includes a trunion drive mechanism 160 operatively associated with each detector head 110, 112. Each trunion drive mechanism 160 is operatively mounted to a respective radial drive mechanism 140 (as best seen in FIG. 14) at a location such that each detector head 110, 112 is pivotable about its respective longitudinal Z₁, Z₂ axis (as indicated by double-headed arrows “E” in FIG. 14). Trunion drive mechanisms 160 can include, and are not limited to, mechanical drive mechanisms and/or pneumatic drive mechanisms.

As seen in FIGS. 1-4 and as will be described in greater detail below, nuclear medicine gantry 100 can be provided with a yoke 124 for operatively mounting detector head 110 to trunion drive mechanism 160 for detector head 110. Yoke 124 is configured and dimensioned to permit tilting (e.g., caudal tilting) of detector head 110 about an axis orthogonal to its longitudinal Z₁ axis, preferably, about an axis which is parallel to the direction of tangential translation of detector head 110, namely, axis X₁. While a single yoke 124 has been shown and described for mounting detector head 110 to trunion drive mechanism 160, it is envisioned and within the scope of the present invention that an additional yoke (not shown) can be provided for mounting detector head 112 to trunion drive mechanism 160.

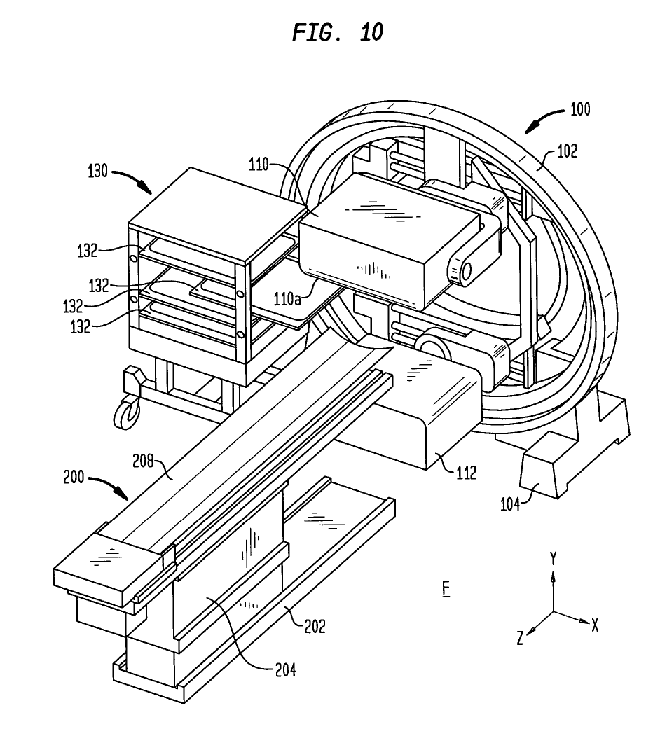

As seen in FIG. 10, nuclear medicine gantry 100 can accommodate use of a cart 130 carrying a plurality of collimators 132 for use in connection with at least one of detector heads 110, 112. In operation, for example, a single collimator 132 is extended from cart 130 and positioned within the field-of-view and attached to face 110a of detector head 110.

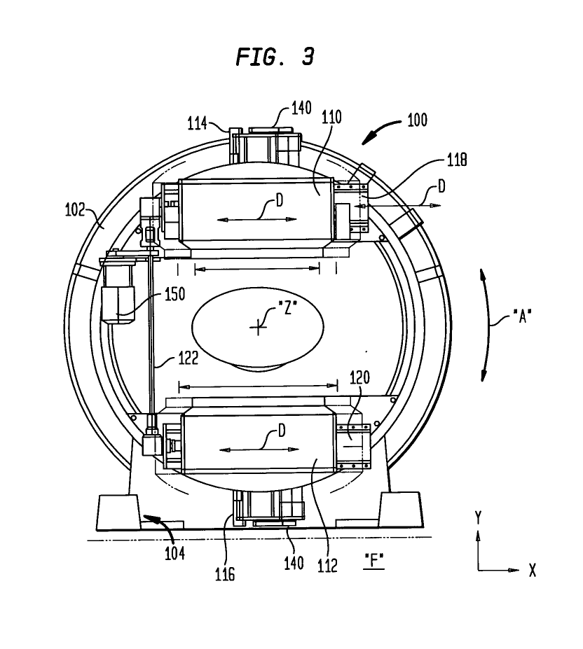

Nuclear medicine gantry 100 is comparatively simple and offers a number of novel features. For example, nuclear medicine gantry 100 enables planar imaging of patients while on a gurney or hospital bed using detector heads 110, 112; enables vertical adjustment of detector heads 110, 112 in direction “D” via tangential drive mechanism, not shown, (see FIG. 11); enables lateral adjustment of detector heads 110, 112 in direction “B” via movement of one or both radial drive mechanisms (see FIG. 12); enables limited whole body imaging of a patient lying on a gurney or hospital bed via movement of one or both radial drive mechanisms (see FIG. 13); enables extra-wide whole body imaging of a patient lying on a telescoping bed (not shown) bed via movement of the tangential drive mechanism (see FIG. 3); and enables extra-large SPECT imaging of a patient lying on the telescoping bed (not shown) via movement of the tangential drive mechanism during imaging (see FIG. 4).

In addition, nuclear medicine gantry 100 provides the further benefits of enabling a variable reconfiguration angle; relatively fast reconfiguration time; ability to be configured in both single detector head and dual detector head versions; ability to do a non-circular orbit around a patient without moving the telescoping bed in any direction; ability to use yoke 124 to position detector head 110 for MUGA studies; and 180° rotation of one of detector heads 110, 112 about the respective longitudinal Z₁, Z₂ axes enables imaging of a patient seated in a standard chair.

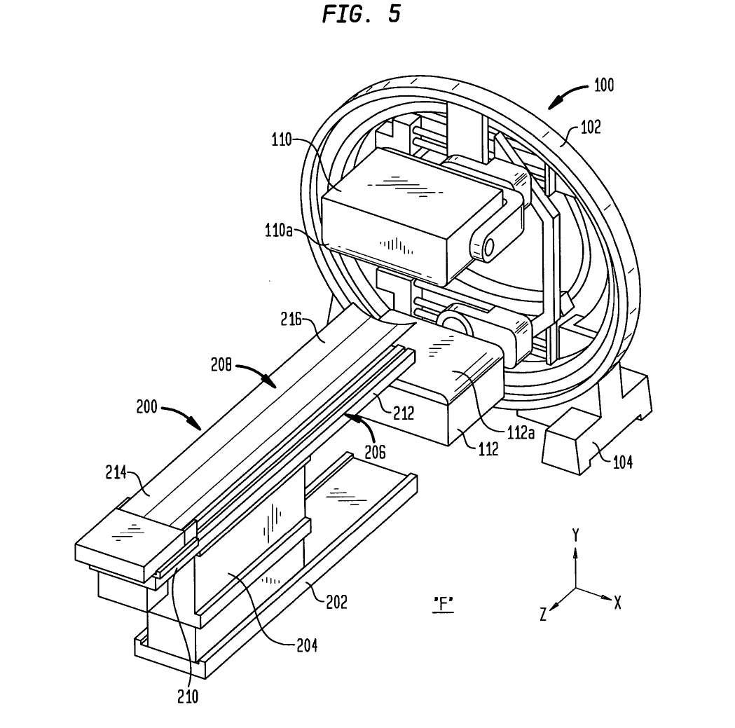

According to the present invention and as seen in FIGS. 5-10, a linear telescoping bed can be provided and is shown and generally indicated at 200. Bed 200 includes a lower frame 202 supported on floor “F”, a lift mechanism 204 operatively supported on to lower frame 202, an upper frame 206 operatively supported on lift mechanism 204 and a pallet 208 translatably supported on upper frame 206. Bed 200 is oriented such that pallet 208 is translatable in directions parallel to the longitudinal Z axis of ring 102. Lift mechanism 204 (e.g., parallelogram style, scissors style, etc.) provides the up and down motion of upper frame 206 and pallet 208 for patient loading and positioning. Upper frame 206 includes a proximal end portion 210 operatively supported on lift mechanism 204 and a distal end portion 212 extending from lift mechanism 204 in a direction toward nuclear medicine gantry 100.

Pallet 208 is configured and adapted such that a proximal end portion 214 thereof is translatably supported on upper frame 206 and a distal end portion 216 thereof is free floating. It is envisioned that bearing cars (not shown), mounted to a lower surface of pallet 208, engage linear rails (not shown) that are fixed to an upper surface of upper frame 206. Translation of pallet 208 relative to upper frame 206 is achieved through a screw drive and/or a belt drive (not shown).

It is contemplated that pallet 208 can be removable and replaced with differing pallets depending on the particular purpose, application and need of the customer. For example, there can be provided a relatively thinner pallet fabricated from aluminum could be used for SPECT and GP (i.e., general purpose) customers wanting low attenuation and close patient proximity; a relatively thicker pallet fabricated from carbon fiber could be used for CT and NM scanning; a scinto-mammography pallet; a pediatric pallet; a wide whole body pallet with armrests; and/or a cardiac specific pallet.

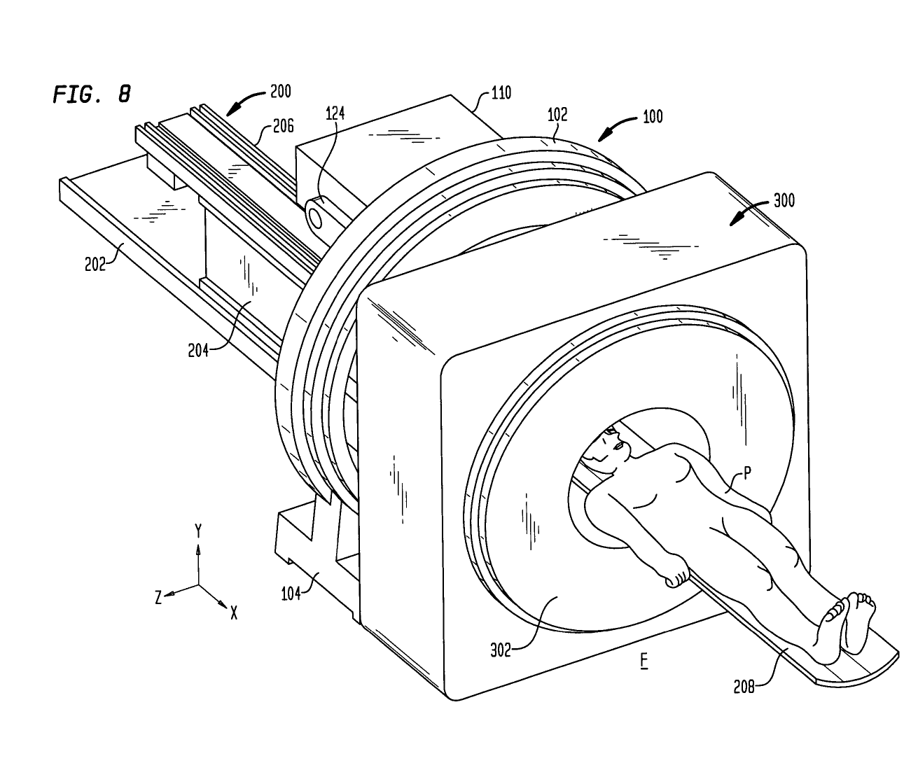

As seen in FIGS. 8, 9 and 19C, a CT scanning apparatus 300, used for functional mapping, attenuation correction, and diagnostic CT is operatively associated with nuclear medicine gantry 100. In one arrangement, for relatively higher speed CT rotation, as seen in FIGS. 8, 9 and 19C, the tube and the detector of CT scanning apparatus 300 can be mounted on a separate independently spinning ring 302 defining a central longitudinal Z axis. Preferably, CT scanning apparatus 300 is a stand alone CT which is positioned behind gantry 100. Preferably, the longitudinal Z axis of ring 102 of nuclear medicine gantry 100 is co-linear with the longitudinal Z axis of ring 302 of CT scanning apparatus 300. In another arrangement (not shown), spinning ring 302 of CT scanning apparatus 300 can be mounted on to ring 102.

With reference to FIGS. 1-19C, various configurations and modes of operation of nuclear medicine gantry 100 will now be described in greater detail.

Turning initially to FIGS. 1-10, it is shown that nuclear medicine gantry 100 can be configured and/or set-up to perform a 180° general purpose tomography. Configuration of nuclear medicine gantry 100 to perform the 180° general purpose tomography includes operation of trunion drive mechanisms 160 to pivot detector heads 110, 112 about axis Z₁, Z₂, respectively, in order to orient a face 110a, 112a, of respective detector heads 110, 112 to a 180° juxtaposed position. Tangential drive mechanism 150 is then operated to center detector heads 110, 112 relative to ring 102 (i.e., axes Y₁ and Y₂ of respective detector heads 110, 112 are aligned with axis Y of ring 102).

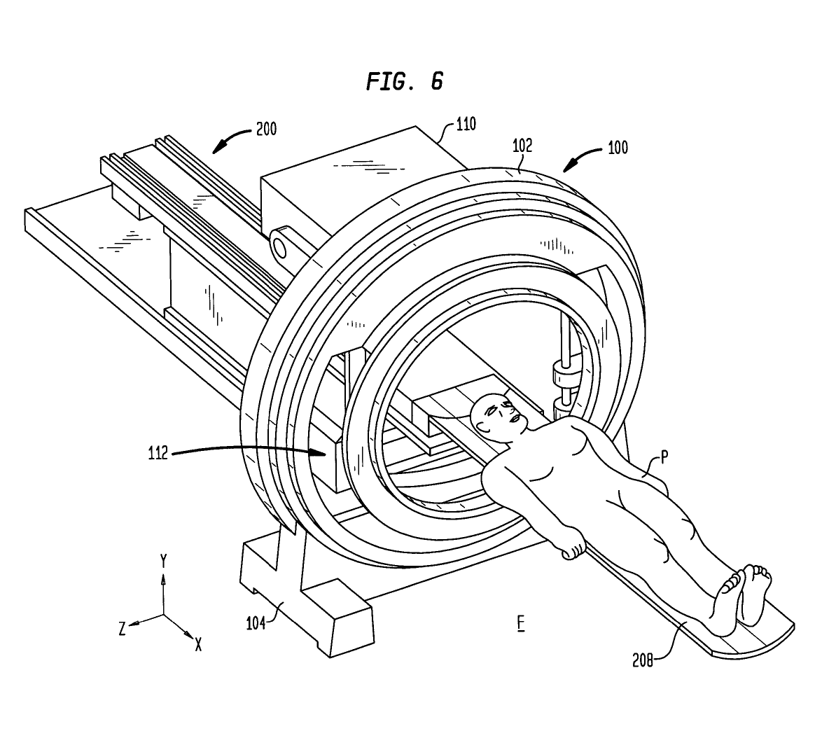

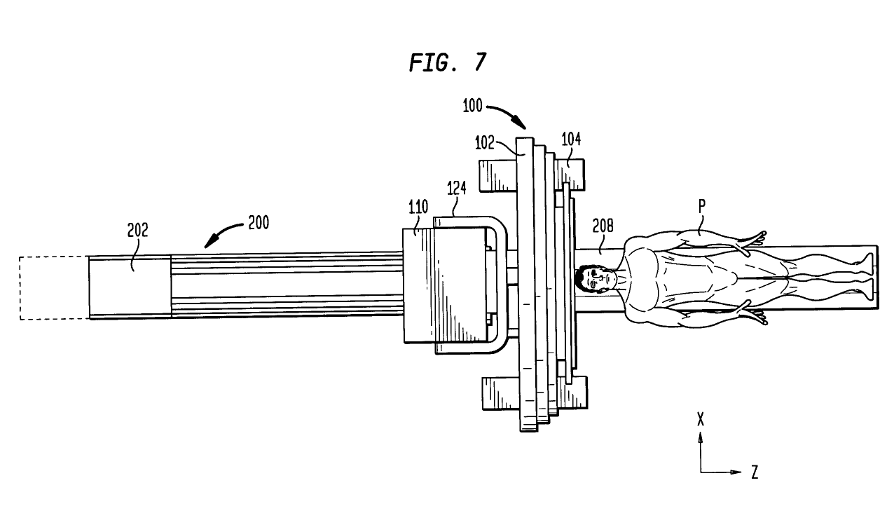

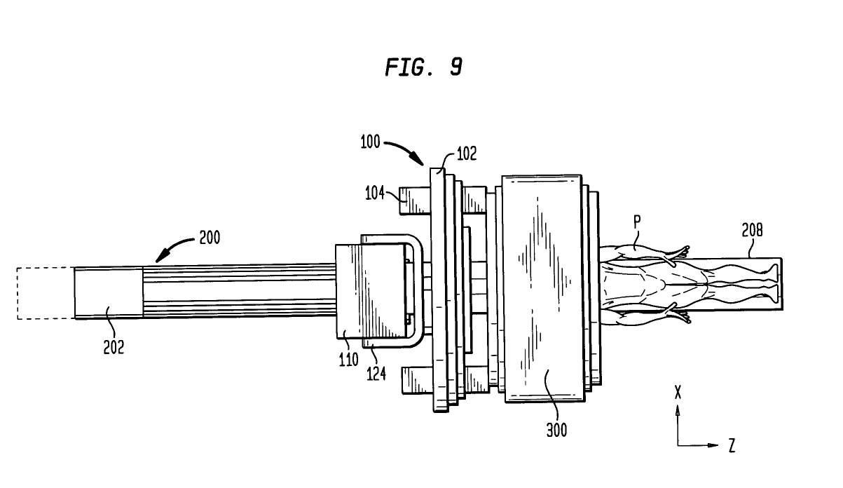

In operation, radial drive mechanisms 140 move detector heads 110, 112 to their radially outermost position and race 106 is rotated about the longitudinal Z axis to radially position detector heads 110, 112 to their appropriate start angle if needed (see FIG. 4). Pallet 208 of patient bed 200 is indexed and driven fully out of the field-of-view of detector heads 110, 112 and lowered to a patient loading height (see FIG. 5). Patient “P” lies on pallet 208, in an appropriate orientation, and pallet 208 is raised and driven fully into the field-of-view of nuclear medicine gantry 100 (e.g., the organ of interest is approximately positioned between detector heads 110, 112) or, in the case of CT scanning, beyond the field-of-view of nuclear medicine gantry 100 (see FIGS. 6 and 7). With patient “P” so positioned the scanning of patient “P” can begin. For circular scan acquisitions, race 106 is rotated about the longitudinal Z axis thus moving detector heads 110, 112 together at a fixed radius and with a fixed 180° separation. For non-circular orbit (NCO) acquisitions, race 106 is rotated about the longitudinal Z axis and radial drive mechanisms 140 are employed to create a non-circular path “0” around patient “P” (see FIGS. 3 and 4). For whole body tomographic acquisitions, pallet 208 of bed 200 is translated into and out of ring 102 to position patient “P” to adjacent fields-of-view. For SPECT-CT acquisitions, as seen in FIGS. 8 and 9, with CT scanner 300 operatively associated with nuclear medicine gantry 100, pallet 208 of bed 200 positions patient “P” into the CT field-of-view following the SPECT scan and translates patient “P” through CT scanner 300 for the CT portion of the scan.

Turning now to FIGS. 11-13, it is shown that nuclear medicine gantry 100 can be configured and/or set-up to perform imaging of a patient “P” (not shown) while on a gurney or hospital bed “G”. Configuration of nuclear medicine gantry 100 to perform imaging of patient “P” on gurney “G” includes positioning detector heads 110, 112 to the 180° juxtaposed configuration, as described above, rotating race 106 to about ±90°, and operating trunion drive mechanisms 160 to rotate each detector head 110, 112 about axis Z₁, Z₂, respectively, in order to orient faces 110a, 112a of detector heads 110, 112 towards and parallel to floor “F”. As seen in FIG. 12, tangential drive mechanism 140 is then operated to raise and/or lower detector heads 110, 112 relative to floor “F” to allow vertical clearance for gurney “G”. As seen in FIG. 13, radial drive mechanisms 140 can then be operated to minimize the gap between detector heads 110, 112. In addition, radial drive mechanisms 140 can be operated to perform coordinated lateral movement of detector heads 110, 112 to perform limited whole body imaging on gurney “G”.

Turning now to FIGS. 14-16, it is shown that nuclear medicine gantry 100 can be configured and/or set-up to perform a 90° cardiac tomography. Configuration of nuclear medicine gantry 100 to perform the 90° cardiac tomography includes operation of trunion drive mechanisms 160 to pivot each detector head 110, 112 about respective axis Z₁, Z₂, as indicated by arrow “E”, in order to orient faces 110a, 112a of detector heads 110, 112, respectively, to a 90° angled orientation relative to one another. Radial drive mechanisms 140 are then operated to move detector heads 110, 112 toward one another until their corners substantially meet. Tangential drive mechanism 150 can then be operated to move detector heads 110, 112 as far away as possible from the longitudinal Z axis while race 106 is rotated about the longitudinal Z axis to position detector heads 110, 112 to a start position of about ±45°.

In operation, patient “P” is positioned in the field-of-view of nuclear medicine gantry 100 in the same manner as above. For 90° circular scan acquisitions, race 106 is rotated about the longitudinal Z axis to simultaneously rotate detector heads 110, 112 about the longitudinal Z axis. The radial distance to the longitudinal Z axis of ring 102 is achieved by operating tangential drive mechanism 150 to move detector heads 110, 112 in a direction which can be considered radial to the longitudinal Z axis. For 90° non-circular orbit scan acquisitions, race 106 will rotate about the longitudinal Z axis as in the 90° circular scan acquisition and superimposed in this rotation the tangential and radial drive mechanisms 150, 140 can be operated to adjust the configuration of heads 110, 112 to trace a non-circular path about patient “P”.

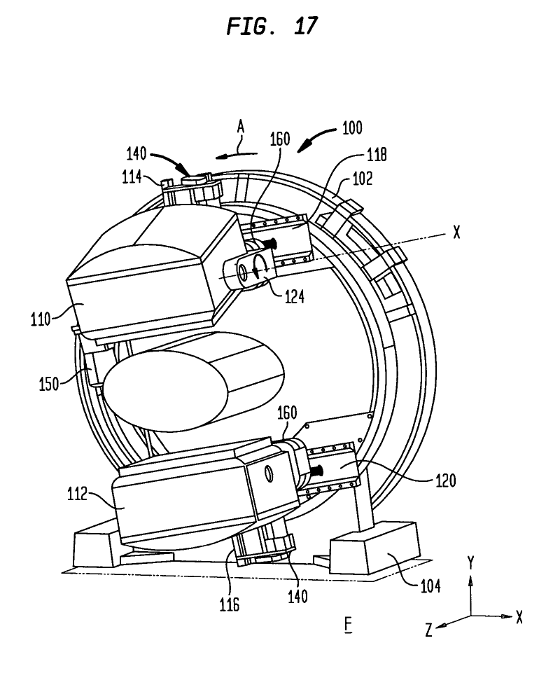

Turning now to FIG. 17, it is shown that nuclear medicine gantry 100 can be configured and/or set-up to perform MUGA studies. Configuration of nuclear medicine gantry 100 to perform the MUGA studies includes positioning detector heads 110, 112 to the 180° juxtaposed configuration, as described above. In operation, yoke 124 enables detector head 110 to be tilted (e.g., caudal tilt) about its axis X₁.

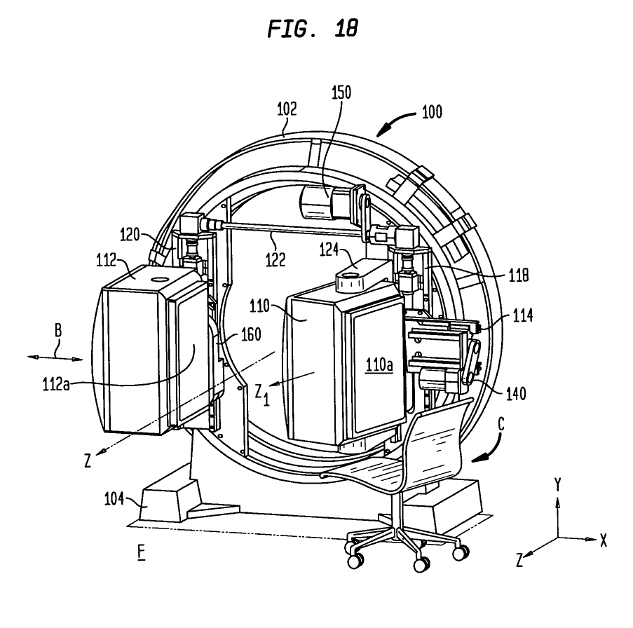

Turning now to FIG. 18, it is shown that nuclear medicine gantry 100 can be configured and/or set-up to perform imaging of a patient “P” (not shown) while in a seated position on a chair “C”. Configuration of nuclear medicine gantry 100 to perform the seated imaging includes positioning detector heads 110, 112 to the 180° juxtaposed configuration, as described above, and rotating race 106 to about +90°. For nuclear medicine gantries 100 not including trunion drive mechanism 160, seated imaging would require patient “P” to be seated on chair “C” between detector heads 110, 112. For nuclear medicine gantries 100 including trunion drive mechanism 160, as shown in FIG. 18, detector head 110 can be rotated 180° about its longitudinal Z₁ axis so that patient “P” can be seated in chair “C” outside nuclear medicine gantry 100.

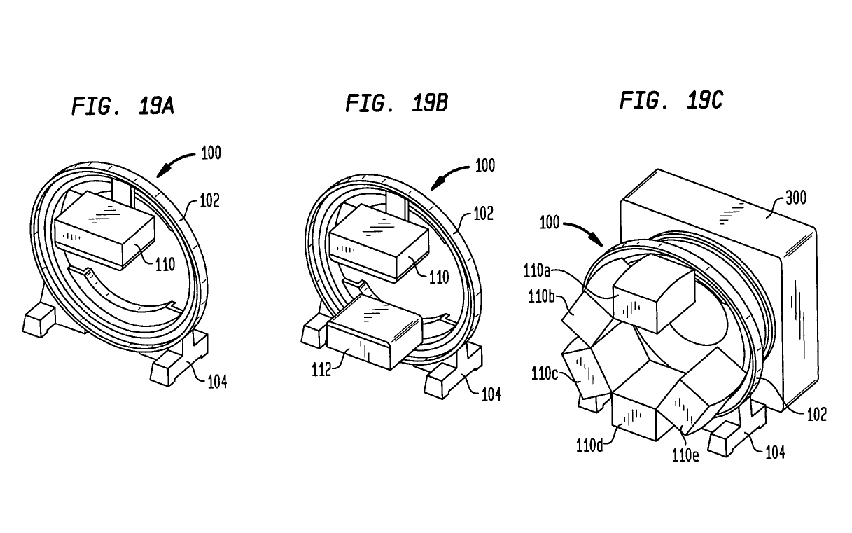

In FIG. 19A, nuclear medicine gantry 100 is provided with a single fixed detector head 110. It is envisioned that nuclear medicine gantry 100 having single head detector 110 can perform 360° circular and non-circular orbit tomographies and whole body planar imaging as described above. The ability to perform MUGA studies and seated imaging requires mounting of detector head 110 to yoke 124 to provide caudal tilt. Cardiac imaging (e.g., circular and non-circular) could be accomplished with single detector head 110 sweeping through a 180° arc due to rotation of race 106 about the longitudinal Z axis.

In FIG. 19B, nuclear medicine gantry 100 is provided with dual detector heads 110, 112 fixed at a 180° juxtaposed relation to one another. It is envisioned that nuclear medicine gantry 100 having dual detector heads 110, 112 fixed at 180° can perform 180° circular and non-circular orbit tomographies and whole body planar imaging as described above. The ability to perform MUGA studies and seated imaging requires mounting of detector head 110 to yoke 124 to provide caudal tilt. Seated imaging could be performed by placing patient “P” between detector heads 110, 112.

In FIG. 19C, nuclear medicine gantry 100 is provided with five detector heads 110a-110e operatively mounted to race 106. As race 106 is rotated about the longitudinal Z axis, detector heads 110a-110e will also rotate about the longitudinal Z axis. As described above, a CT imaging apparatus 300 can be operatively associated with nuclear medicine gantry 100 to perform CT image scans. It is envisioned that this embodiment of nuclear medicine gantry 100 is advantageous fro PET imaging.

Although the present invention has been described in accordance with the embodiments shown, one of ordinary skill in the art will readily recognize that there could be variations to the embodiment and these variations would be within the spirit and scope of the present invention. Accordingly, many modifications may be made by one of ordinary skill in the art without departing from the spirit and scope of the appended claims.

What is claimed is:

1. A nuclear medicine gantry, comprising:
a ring defining a central longitudinal axis; and
at least one detector head mounted to the ring, the at least one detector head being rotatable about the longitudinal axis, movable in radial directions relative to the longitudinal axis, movable in tangential directions relative to a circle whose center is coincident with the longitudinal axis, and pivotable about a first pivot axis which is parallel to the longitudinal axis.

2. The nuclear medicine gantry of claim 1, wherein each detector head is pivotable about a second pivot axis which is orthogonal to the first pivot axis.

3. The nuclear medicine gantry of claim 2, wherein the ring is rotatable about the longitudinal axis.

4. The nuclear medicine gantry of claim 3, further comprising a separate tangential drive mechanism configured and adapted to effectuate the movement of each detector head in directions tangential to a circle whose center is coincident with the longitudinal axis.

5. The nuclear medicine gantry of claim 4, further comprising at least one trunion drive mechanism operatively associated with each detector head, each trunion drive mechanism being configured and adapted to effectuate the pivoting of each detector head about the first pivot axis.

6. The nuclear medicine gantry of claim 5, further comprising at least one radial drive mechanism operatively associated with each detector head, each radial drive mechanism being configured and adapted to effectuate the movement of each detector head in directions radial to the longitudinal axis.

7. The nuclear medicine gantry of claim 1, further comprising a treatment bed configured and adapted to provide motion parallel to and transverse to the longitudinal axis.

8. A nuclear medicine gantry comprising:
a ring defining X, Y and Z axes, wherein the Z axis of the ring is co-linear with a central longitudinal axis of the ring;
a first detector head operatively mounted to the ring, the first detector head defining first detector head X, Y and Z axes, wherein the first detector head is translatable along and rotatable about at least one of the first detector head X, Y and Z axes; and
a second detector head operatively mounted to the ring, the second detector head defining second detector head X, Y and Z axes, wherein the second detector head is translatable along and rotatable about at least one of the second detector head X, Y and Z axes, wherein the Z axis of the ring and the first and second detector head Z axes are parallel.

9. The nuclear medicine gantry of claim 8, wherein the ring is rotatable about the Z axis of the ring.

10. The nuclear medicine gantry of claim 9, wherein each of the first and second detector heads is pivotable about a respective first and second Z axis.

11. The nuclear medicine gantry of claim 10, further comprising a tangential drive mechanism operatively connected to the first and second detector heads, the tangential drive mechanism being configured and adapted to move the first and the second detector heads in directions tangential to a circle whose center is coincident with the Z axis of the ring.

12. The nuclear medicine gantry of claim 11, further comprising at least one radial drive mechanism operatively connected to each of the first and second detector heads, each radial drive mechanism being configured and adapted to move a respective one of the first and second detector heads in directions radial to the Z axis of the ring.

13. The nuclear medicine gantry of claim 12, further comprising at least one trunion drive mechanism operatively connected to each of the first and second detector heads, each trunion drive mechanism being configured and adapted to pivot a respective one of the first and second detector heads about respective first and second Z axis.

17. A nuclear medicine gantry comprising:
a ring defining a central longitudinal axis;
means for rotating the ring about the central longitudinal axis;
at least one detector head operatively mounted to the ring;
means for moving each detector head in directions tangential to the central axis; and
means for pivoting each detector head about a pivot axis which is parallel to the central longitudinal axis.

18. The nuclear medicine gantry of claim 17, wherein each detector head is pivotable about an axis which is orthogonal with respect to the pivot axis.

19. A nuclear medicine gantry, comprising:
a ring defining a central longitudinal axis;
means for rotating the ring about the central longitudinal axis;
a first detector head operatively mounted to the ring;
means for moving the first detector head in directions radial to the central longitudinal axis;
means for pivoting the first detector head about an axis parallel to the central longitudinal axis;
a second detector head operatively mounted to the ring;
means for moving the second detector head in directions radial to the central longitudinal axis;
means for pivoting the second detector head about an axis parallel to the central longitudinal axis; and
means for moving the first and second detector heads in directions tangential to a circle whose center is coincident with the central longitudinal axis.

20. A method of performing an image scan, comprising the steps of:
providing a nuclear medicine gantry, the nuclear medicine gantry including:
a ring defining a central longitudinal axis wherein the ring is rotatable about the central axis; and
a first and a second detector head mounted to the ring, each of the first and second detector heads being pivotable about a first pivot axis parallel to the central longitudinal axis, translatable in directions tangential to a circle whose center is coincident with the central longitudinal axis, and translatable in directions radial to the central longitudinal axis;
configuring the nuclear medicine gantry such that an operative face of the first and the second detector head is in at least one of juxtaposed relation to one another, orthogonal relation to one another, angled relation to one another, and parallel relation to one another; and
performing the image scan.

21. The method according to claim 20, wherein the nuclear medicine gantry further comprises means for rotating the ring about the central longitudinal axis.

22. The method according to claim 21, wherein the nuclear medicine gantry further comprises means for translating and means for pivoting each of the first and second detector heads.

23. The method according to claim 22, wherein the method comprises the step of performing at least one of a 180° tomography, a 90° Cardiac tomography, a circular scan acquisition, a non-circular orbit scan acquisition, a non-circular pre-scan acquisition, a CT cardiac attenuation correction, an extra wide whole-body planar acquisition, extra-wide SPECT imaging, and an MUGA.

24. The method according to claim 22, further comprising the step of configuring the nuclear medicine gantry to perform at least one of an image acquisition over a gurney, of an image acquisition of an individual standing between the first and second detector heads, and of an image acquisition of an individual positioned radially outward of the first and second detector heads.

25. An imaging system, comprising:
a nuclear medicine gantry, the nuclear medicine gantry including:
a ring defining a central longitudinal axis; and
at least one detector head mounted to the ring, the at least one detector head being rotatable about the longitudinal axis, movable in radial directions relative to the longitudinal axis, movable in tangential directions relative to a circle whose center is coincident with the longitudinal axis, and pivotable about a first pivot axis which is parallel to the longitudinal axis; and
a CT imaging apparatus operatively positionable adjacent the nuclear medicine gantry, the CT imaging apparatus a rotating ring defining a central longitudinal axis which is co-linear with the longitudinal axis of the ring of the nuclear medicine gantry.

26. The imaging system according to claim 25, further comprising a bed operatively positionable adjacent the nuclear medicine gantry, the bed including a pallet configured and adapted to be translatable in directions parallel to the longitudinal axis of the ring of the nuclear medicine gantry.
